(19) United States
(12) Patent Application Publication
(10) Pub. No.: US 2026/0246177 A1
(43) Pub. Date: Aug. 20, 2026

(54) PRINTED CIRCUIT BOARD CONNECTOR

(71) Applicant: HUBER+SUHNER AG, CH-9100 HERISAU (CH)

(72) Inventors: Martin WAGNER, Steinach (CH); Urs FRISCHKNECHT, Herisau (CH); Franz MANSER, Herisau (CH); Patrick MATTLE, Herisau (CH)

(73) Assignee: HUBER+SUHNER AG, CH-9100 HERISAU (CH)

(21) Appl. No.: 19/161,015

(22) PCT Filed: Feb. 28, 2024
(86) PCT No.: PCT/EP2024/055139

§ 371 Date: Aug. 29, 2025

(30) Foreign Application Priority Data
Mar. 10, 2023 (DE) 102023106006.6

(51) Int. Cl. H01R 12/91; H01R 12/70; H01R 12/71; H01R 13/187; H01R 13/502

(52) U.S. Cl. CPC H01R 12/91; H01R 12/707; H01R 12/712; H01R 13/187; H01R 13/5025

(57) ABSTRACT

A board to board connector assembly (1) for interconnecting a first and a second printed circuit board, spaced a distance apart from each other, includes a first connector sub-assembly (2) and a second connector sub-assembly (3). The connector sub-assemblies (2, 3) are interconnected to each other in an assembled state by a plug connector

### BACKGROUND OF THE INVENTION

### Field of the Invention

The present invention relates to a board to board connector assembly for interconnecting a first and a second printed circuit board spaced a distance apart from each other, to a plug connector, in particular a plug connector for such a board to board connector assembly, as well as to a method for producing such a plug connector, according to the preambles of the independent claims.

### Discussion of Related Art

In high-frequency technology, board-to board connectors are widely used for connecting different high-frequency assemblies, such as Printed Circuit Boards (PCBs) that carry high-frequency circuitry. In a typical arrangement, PCBs are arranged in a parallel manner with a distance in a typical range of 5 mm to 20 mm to each other, with a number of high-frequency galvanic connections being present between them.

By way of example, US20190036240A1 discloses a board to board connector assembly comprising a coaxial plug connector and at least one plug socket. The coaxial plug connector comprises an electrically conductive inner conductor, an electrically conductive outer conductor disposed at a spacing around the inner conductor and a sleeve made of an insulating plastic. This coaxial plug connector is made of one piece, is tubular, and has an annular cross-section.

The plug socket described in this document further comprises a spring cage and a spring tip. The spring cage is coaxially disposed around the spring tip and adapted to make an electrical connection with the outer conductor. The spring tip, on the other hand, is adapted to make an electrical connection with the inner conductor. The spring cage comprises several elastic spring tongues by which sections of the spring cage are biased and pressed against the outer conductor of the coaxial plug connector.

This prior art arrangement has the advantage that the plug connector has a relatively simple design and can be produced by the meter. It thus can be cut to a desired length, as need for a specific board to board distance. This allows for manufacture and supply of plug connectors of different lengths, depending on current demand.

However, in application of the aforementioned assembly, electrical connection between the plug connector and the plug socket has turned out to be unreliable. In particular, if the plug connector is tilted with respect to the center axis of the plug socket or is offset from the same (the center axis is usually perpendicular to one or both of the PCBs). Connection between the spring cage and the outer conductor is thus negatively affected, at least partially around their circumference.

It is therefore a problem underlying the present invention to address the above-mentioned shortcomings in the prior art. In particular, it is a problem underlying the present invention to provide a board to board connector assembly of the aforementioned kind with an improved plug socket. This plug socket should allow for a more reliable electrical and mechanical connection between the outer conductor of the plug connector and the spring cage of the plug socket, even if the latter is tilted or offset relative to the center axis of the plug socket. Furthermore, the connector assembly should be durable, i.e. allow for many connection cycles, and cost-effective in manufacture.

### SUMMARY OF THE INVENTION

These problems are solved by a board to board connector assembly, a plug connector and a method for producing such a plug connector with the features according to the independent claims.

In a first aspect, the present invention relates to a board to board connector assembly for interconnecting a first and a second printed circuit board spaced a distance apart from each other. The board to board connector assembly comprises a first connector sub-assembly and a second connector sub-assembly, interconnected to each other in an assembled state by a plug connector. The plug connector comprises:
a. An inner conductor and an outer conductor extending in a direction of a center axis A1; and
b. a spacer arranged between and positioning the inner conductor with respect to the outer conductor.

At least one of the first and/or second connector sub-assemblies comprises a spring cage in form of a tubular sleeve, having a side wall comprising several openings. Each opening has at least one therein arranged spring element, which at a proximal end is connected to the tubular sleeve, and at a distal end extends above an inner face of the tubular sleeve, forming at least one contact zone. In the assembled state, the at least one contact zone is in electrical contact with the outer conductor of the plug connector.

Arranging the at least one spring element in an opening of the side wall allows for a higher freedom of design with regard to position, orientation and shape of the spring element. A more reliable electrical connection between the outer conductor of the plug connector and the spring element can thus be achieved. This is in particular the case, if the plug connector is tilted or offset relative to the center axis A1 of the respective connector sub-assembly.

The at least one spring element can be, between the proximal end and the distal end, at least partially arranged along a secant of the tubular sleeve, in a top view. Orientation along a secant allows the at least one spring element to deflect in a plane perpendicular to the center axis A1 of the connector sub-assembly. This kind of contact configuration allows a simple geometrical shape of the plug connector. The plug connector can be used with only minor deformations or even without deformation. Axial captivation can be implemented effortlessly.

The at least one spring element can be, between the proximal end and the distal end, bent along the secant, preferably at least twice. This bending of the spring element allows for an improved contact angle between the spring element and the outer conductor of the plug connector. Leakage currents are therefore substantially avoided.

The at least one of the spring element can become wider between the proximal end and the distal end along the secant. This has on one hand the advantage that the spring element is relatively narrow at its proximal end, where it is connected to the tubular sleeve, which results in high flexibly of the spring element in this area. On the other hand, the spring element is relatively wide, and therefore also rigid, at tis distal end. As a result, a large and stiff contact zone can be formed, allowing for better contact.

At least two spring elements can be arranged in one opening, with the contact zones of the at least two spring elements being arranged adjacent to each other or at opposite ends of the opening.

The tubular sleeve can comprise at least a first strap encircling the center axis A1, with the at least one spring element being connected to the at least one strap by a bridge. This offers a high level of structural stability to the spring cage.

The bridge can have an extension in a direction parallel to the center axis A1, is preferably oriented parallel to the center axis A1, and optionally extends above an outer face of the tubular sleeve. If the bridge extends above an outer face of the tubular sleeve, a clamping can be achieved upon insertion of the spring element into a connector sub-assembly, in particular into a hollow outer contact of a connector sub-assembly. This results in stable mounting of the spring element in the connector sub-assembly. Furthermore, good electrical contact between the spring element and the outer contact is achieved. A loose contact is substantially avoided.

The board to board connector assembly can further comprise an outer contact, in particular a barrel-shaped outer contact, in which the spring cage is placed. Especially, the spring cage is clamped between an inner wall of the barrel-shaped outer contact, as described in the preceding paragraph.

The bridge can extend from the first strap to a second strap, and optionally taper between the first strap and the second strap. This makes the spring cage stable against twisting distortion.

The at least one contact zone can be linear or punctiform, preferably linear. A linear contact zone has the advantage that the plug connector can be centered and axially aligned, without applying force in axial direction and with positive effect on the electrical performance.

The at least one contact zone can comprise at least one sloped inlet along the center axis A1. This facilitates insertion of the plug connector into the spring cage by avoiding the risk of the plug connector getting caught one or more spring elements.

The at least one contact zone can comprise an arrangement of several sloped inlets along the center axis A1. The inlets can be arranged symmetrically or asymmetrically.

The spring cage can be made as a stamping-and-bending part, which is bent with respect to the center axis A1. The stamping-and-bending part can be welded along an interface or interlocked. Alternatively, the stamping-and-bending part can also be left open at the interface, if the material has sufficient thickness and therefore stiffness. All of these options allow for cost-effective mass production of such spring cages.

As yet another alternative, the spring cage can be made by injection molding or additive manufacturing, such as laser sintering.

After manufacturing, the spring cage can be subjected to thermal treatment, in order to achieve the desired elastic properties.

At least one of the first and/or second connector sub-assemblies can comprise an inner contact. The inner contact can be a stamping part made of a sheet metal, which comprises at least two spring fingers. In the assembled state, the at least two spring fingers can extend along the center axis A1 into the inner conductor or encompass the inner conductor. Alternatively, the inner contact can be a bent wire, which comprises at least two spring fingers, which in the assembled state extend along the center axis A1 into the inner conductor or encompass the inner conductor. The inner contact can comprise two, preferably exactly two, spring fingers, which are either arranged in one common plane, or inversely twisted out of a plane lying in between the two spring fingers.

The first connector sub-assembly and/or the second connector sub-assembly can comprise an isolating element, which comprises a recess, in which the inner contact is arranged. The isolating element electrically isolates and aligns with respect to each other the inner contact from the spring cage, and optionally also the outer contact, if applicable.

The isolating element can comprise at least one lug, which laterally extends, away from the isolating element with respect to the center axis A1. The lug can engage, in the assembled state, with a recess of the outer conductor. In this manner, the angular position of the isolating element in the outer conductor can be well defined. Since the isolating element comprises a recess, in which the inner contact is arranged, also the angular position of the inner contact with respect to the outer conductor can be defined. This is of particular importance for mounting the connector sub-assembly on a PCB, in particular as a surface mounted device (SMD).

In a board to board connector assembly of the present invention, the outer contact and/or the spring element of the first connector sub-assembly can have the same extension along the center axis A1 as the outer contact and/or the spring element of the second connector sub-assembly.

It can be of advantage, if the plug connector is latched to the second connector sub-assembly with respect to a movement along its center axis, while the plug connector can move freely along the center axis of the first the connector sub-assembly. In such a setup, the outer contact and/or the spring element of the first connector sub-assembly can also have a larger extension along the center axis A1 than the outer contact and/or the spring element of the second connector sub-assembly.

In such an embodiment, the outer conductor of the plug connector can comprise a recess with which the spring element, in particular the spring element of the second connector sub-assembly, engages in the assembled state. This allows latching the plug connector in the spring cage along the center axis A1 in the assembled state. Such a latching can be advantageous, if the board to board connector assembly is taken apart. Specifically, in such a configuration, the plug connector will remain with the connector sub-assembly to which it is latched. Especially when two PCBs with several board to board connector assemblies are separated, this can be an advantage for handling.

Alternatively, or additionally, a collar can be arranged at the outer conductor of the plug connector and extend radially away from the plug connector, to engage, in an assembled state, with the first connector sub-assembly or the second connector sub-assembly, in particular with a spring element thereof, to secure the plug connector along the center axis A1.

In a second aspect, the present invention relates to a plug connector, in particular a plug connector for a board to board connector assembly as described herein above. The plug connector comprises:
a. An inner conductor and an outer conductor extending in a direction of a center axis A1; and
b. a spacer arranged between and positioning the inner conductor with respect to the outer conductor.

The spacer of the plug connector is a layer of insulating material, which is extruded over the inner conductor.

Such a plug connector has the advantage that it has a relatively simple design and can be produced by the meter. It thus can be cut to a desired length, as needed for a specific board to board distance. This allows for manufacture and supply of plug connectors of different lengths, depending on current demand. In this context, extruding the spacer as a layer of insulating material over the inner conductor allows for efficient production of the plug connector. Furthermore, the extruded material has good isolation properties.

The inner conductor can be a hollow tube or a cylindrical pin, optionally comprising indentations. The hollow tube can be made of a bent metallic sheet material, which is welded together along an interface. The cylindrical pin can be made by a pulling process.

The outer conductor can be tubular and made of metallic material. The outer conductor can be brought to the final diameter by a pulling process.

The board to board connector assembly as described herein above can comprise a plug connector as presently described.

In a third aspect, the present invention relates to a method for producing a plug connector, in particular a plug connector as described herein above. The method comprises the following steps:
Providing an inner conductor;
Extruding a spacer in form of a layer onto the inner conductor;
Placing the inner conductor and spacer in an outer conductor in form of a tubular semi-finished product made of metallic material;
Shaping the outer conductor to bring the diameter of the tubular semi-finished product to the final diameter;
Cutting the plug connector to the desired length.

Placing the inner conductor and spacer in an outer conductor can be achieved by sliding the outer conductor onto the spacer. Alternatively, the outer conductor can also be rolled around the spacer from a direction perpendicular to the center axis of the outer conductor and spacer. The outer conductor can then be welded along an axial interface.

Shaping the outer conductor can be achieved by a pulling process. Alternatively, the outer conductor can also be roll-formed. The outer conductor can then be welded along an axial interface.

In a particular embodiment of the present invention, the metal parts of the plug connector and/or connector sub-assemblies can be plated with another metal, in particular selected form the group consisting of silver, gold and tin. However, it goes without saying that the present invention is not limited to plated metal parts, and especially not to the mentioned plating materials.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described invention will be more fully understood from the detailed description given herein below and the accompanying drawings which should not be considered limiting to the invention described in the appended claims.

FIG. 1 shows a perspective exploded view of a board to board connector assembly according to the present invention;

FIG. 2 shows a perspective view of the bottom connector sub-assembly of the board to board connector assembly according to FIG. 1;

FIG. 3 shows a perspective view of an alternative connector sub-assembly;

FIG. 4 shows a perspective view of a further alternative connector sub-assembly;

FIG. 5 shows a bottom view of the connector sub-assembly according to FIG. 4;

FIG. 6 shows a perspective view of yet another alternative connector sub-assembly;

FIG. 7 shows a bottom view of the connector sub-assembly according to FIG. 6;

FIG. 8a shows a side view of the board to board connector assembly according to FIG. 1;

FIG. 8b shows a sectional view of the board to board connector assembly according to FIG. 1;

FIG. 8c shows a partial enlarged view of FIG. 8b;

FIG. 9 shows a perspective sectional view of an alternative embodiment of a board to board connector assembly according to the present invention;

FIG. 10 shows a perspective sectional view of an alternative embodiment of a board to board connector assembly according to the present invention;

FIG. 11 shows a exploded sectional view of a board to board connector assembly according to the present invention;

FIG. 12 shows a perspective sectional view of a board to board connector assembly according to FIG. 11;

FIG. 13 shows a perspective sectional view of an alternative embodiment of a board to board connector assembly according to the present invention;

FIG. 14 shows a perspective view of a spring cage of a board to board connector assembly according to the present invention;

FIG. 15 shows a top view of the a spring cage according to FIG. 14;

FIG. 16 shows a perspective view of an alternative embodiment of a spring cage for a board to board connector assembly according to the present invention;

FIG. 17 shows a perspective view of an alternative embodiment of a spring cage for a board to board connector assembly according to the present invention;

FIG. 18 shows a perspective view of an alternative embodiment of a spring cage for a board to board connector assembly according to the present invention; and

FIG. 19 shows a perspective view of an alternative embodiment of a spring cage for a board to board connector assembly according to the present invention.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

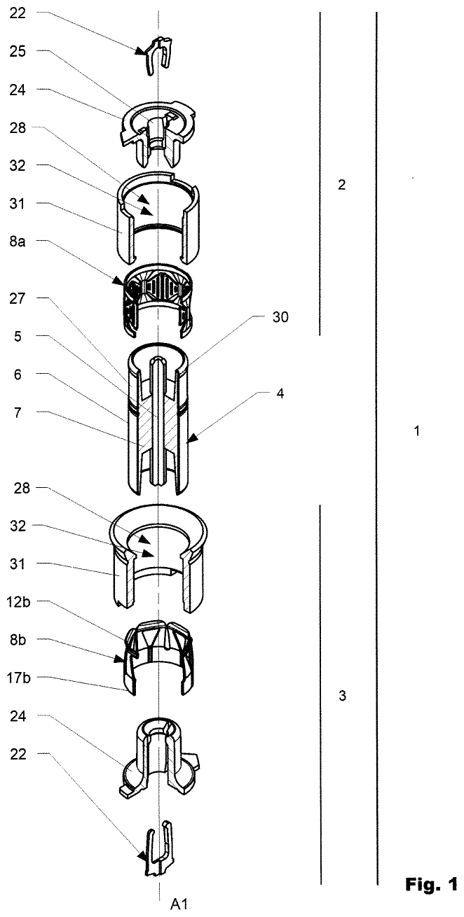

FIG. 1 shows a board to board connector assembly 1 according to the present invention. The assembly 1 comprises a first connector sub-assembly 2 and a second connector sub-assembly 3, which are connected by a plug connector 4. The connector assembly 1 is used for interconnecting a first and a second printed circuit board (PCB) spaced a distance apart from each other. For this purpose, the first connector sub-assembly 2 and the second connector sub-assembly 3 are each mounted on one PCB as surface mounted devices (SMDs).

Turning to the first connector sub-assembly 2, it can be seen that the outer housing of the same comprises a barrel-shaped outer contact 31, which is made of an electrically conductive material, usually a metal. Into a recess 28 of the outer contact 31 is placed a spring cage 8a. The spring cage 8a is clamped in the recess 28. Furthermore, it is positively locked through an isolating element 24, which closes the recess 28. This isolating element 24 comprises a recess 25, which carries an inner contact 22.

The second connector sub-assembly 3 has a setup, which is essentially identical to the one of the first connector sub-assembly 2. A main difference is the construction of the spring cage 8b. This spring cage 8b is in the form of a tubular sleeve. It comprises a plurality of spring elements 12b, which are oriented in a direction parallel to a center axis A1 of the sub-assembly 3. The spring elements 12b are connected by straps 17b. Unlike spring cage 8a, spring cage 8b is not according to the present invention.

The plug connector 4 comprises an inner conductor 5 as well as an outer conductor 6, which are separated by a spacer 7. The outer conductor 5 comprises a recess 27, presently in the shape of a circumferential groove, with which a spring element of the first connector sub-assembly 2 engages in the assembled state. This allows locking the plug connector 4 in the first connector sub-assembly 2.

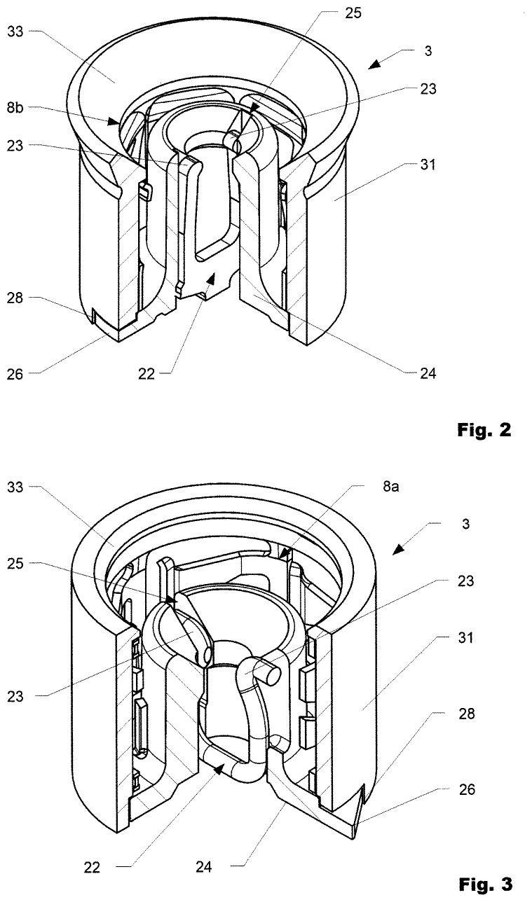

FIG. 2 shows the lower second connector sub-assembly 3 of the board to board connector assembly 1 according to FIG. 1 in an assembled state. It can be seen that the isolating element 24 comprises a lug 26, which laterally extends away from the isolating element 24 with respect to its center axis. The lug engages with a recess 28 of the outer conductor 31. This allows locking relative rotation between the isolating element 24 and the outer conductor 31. Defining the relative angular position between these two parts is important, because the inner contact 22 is held in a recess 25 of the isolating element 24. The inner contact 22 needs to be properly aligned for mounting connector sub-assembly 3 on a PCB. In this embodiment, the inner contact 22 is a flat punched sheet metal plate. Furthermore, the outer contact 31 has a funnel-shaped rim, in order to facilitate insertion of the plug connector 4 into the connector sub-assembly 3.

FIG. 3 shows an alternative version of a lower second connector sub-assembly 3. It can be seen that the inner contact 22 has the shape of a bent wire, which comprises two spring fingers 23. The spring fingers 23 are arranged in one common plane. Furthermore, the lug 26 extends beyond the outer face of the outer conductor 31. This allows to rotationally align the connector sub-assembly 3, when it is placed on a PCB by a pick and place machine.

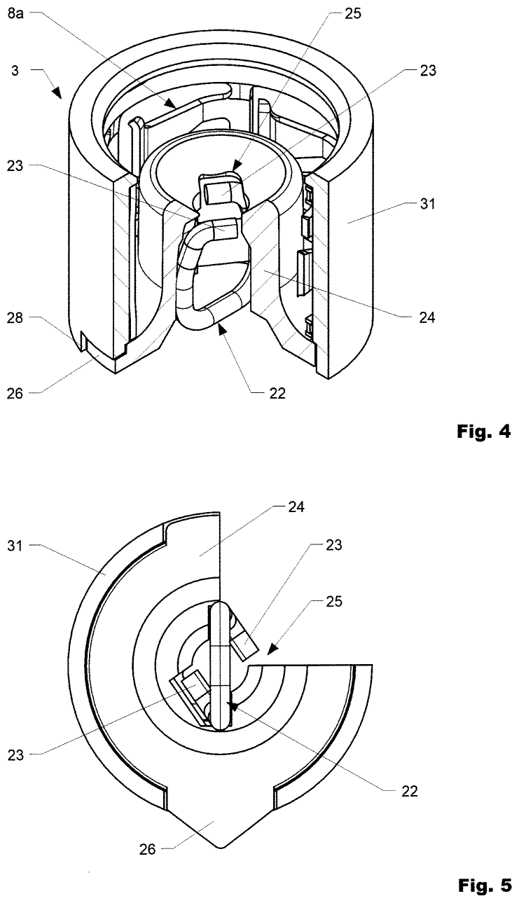

FIG. 4 shows an further alternative embodiment of a lower second connector sub-assembly 3. Also here, the inner contact 22 is in the form of a bent wire. However, unlike to FIG. 3, this inner contact 22 is not flat, i.e. the spring fingers 23 are not arranged in one common plane, but are in a twisted configuration. As can in particular seen from FIG. 5, the two spring fingers 23 are inversely twisted out of a plane lying in between them (FIG. 5 shows a perspective along this plane). From the bottom view of FIG. 5 the lug 26 extending beyond the outer face of the outer conductor 31 can also be seen.

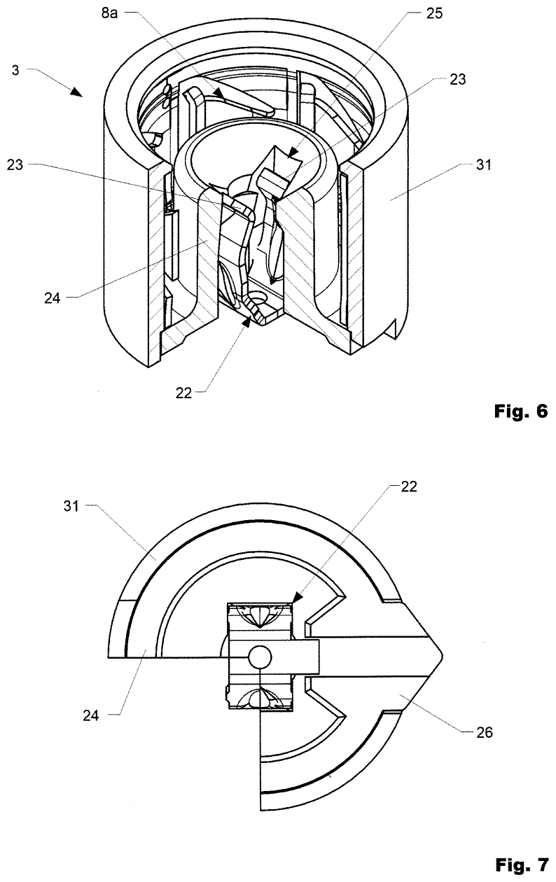

FIGS. 6 and 7 show yet another embodiment of a lower second connector sub-assembly 3 according to the present invention. Similar to the assembly according to FIG. 2, the inner contact 22 is also a punched sheet metal plate. However, this inner contact 22 is not flat but a three dimensional stamping-and-bending part, in which the sheet metal plate has been bent in the form of a U. Although this inner contact 22 has a more complex geometry than the one shown in FIG. 2, and is therefore also more costly in production, a greater flexibility of the spring fingers 23 can be achieved, which leads to improved contact. This is especially the case, if the plug connector is tilted with respect to the center axis of the plug socket or is offset from the same.

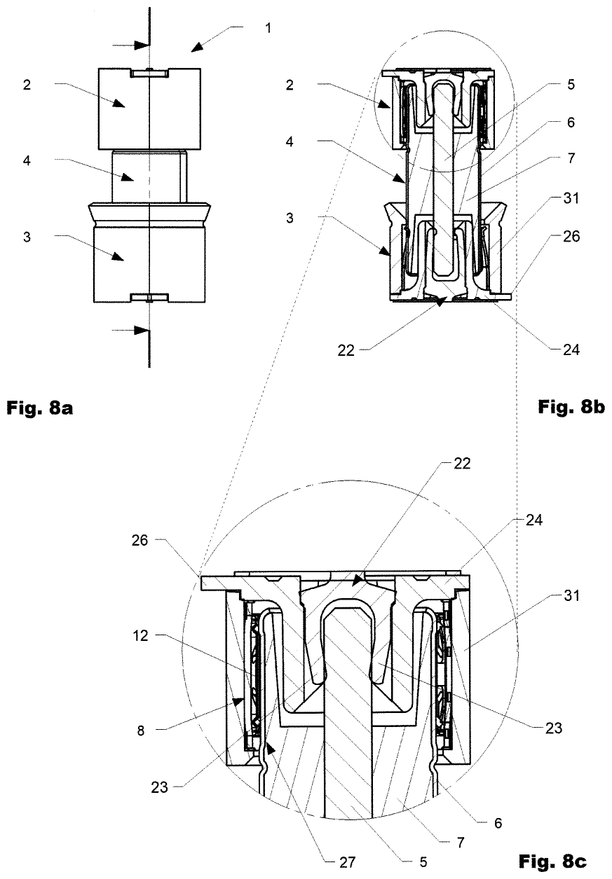

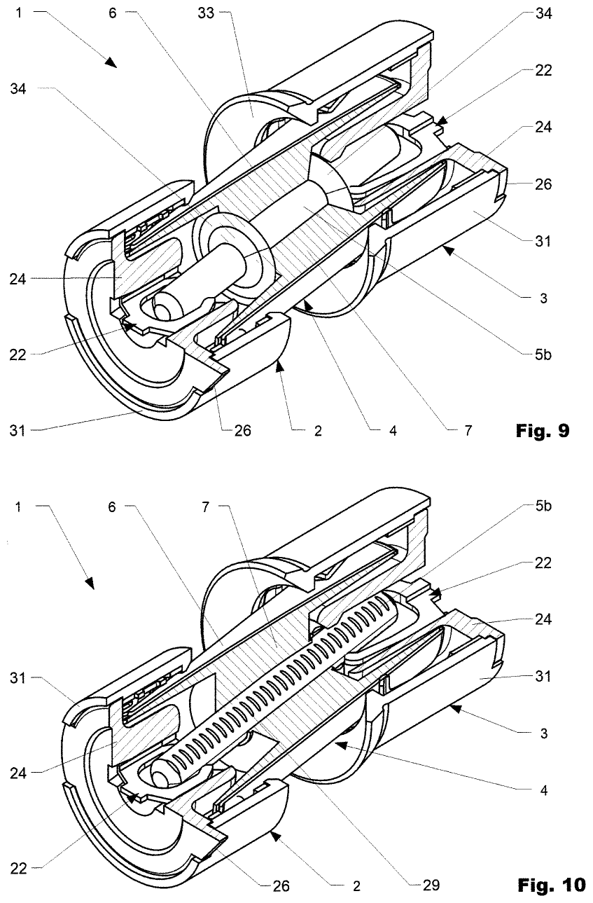

From FIGS. 8a to 8c, further details of the board to board connector assembly 1 according to FIG. 1 become apparent. In particular from the enlarged view of FIG. 8c it can be seen that the inner contact 22 comprises two spring fingers 23, which extend along the center axis A1 of the connector sub-assembly 2. In the shown assembled state, the spring fingers 23 encompass the inner conductor 5 of the plug connector 4. Furthermore, engagement of the of the spring elements 12 of the spring cage 8 with the recess 27 of the of the plug connector 4 can be better discerned.

FIG. 9 shows an alternative embodiment of a board to board connector assembly 1 according to the present invention. In this embodiment, the inner conductor of the plug connector 4 is a cylindrical pin 5b comprising disk shaped stop faces 34, which limit the spacer 7 along the center axis A1. Also in FIG. 10, the inner conductor is a cylindrical pin 5b, but comprising indentations 29.

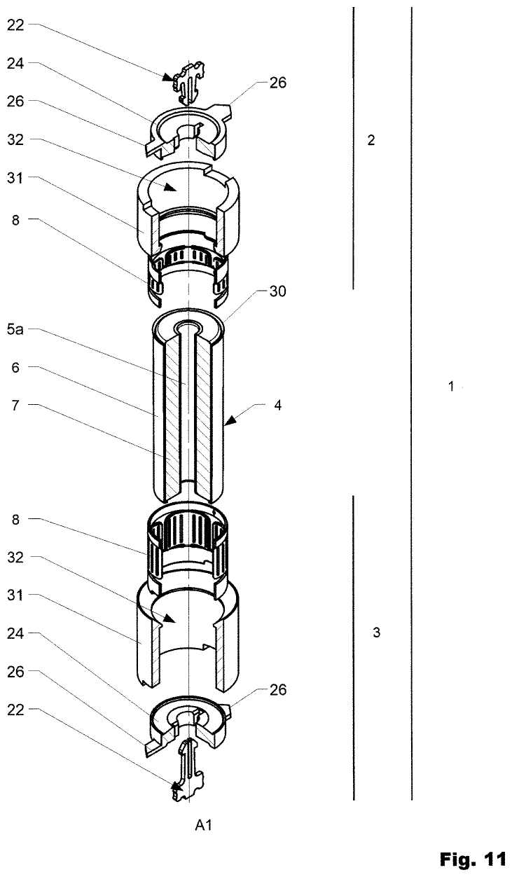

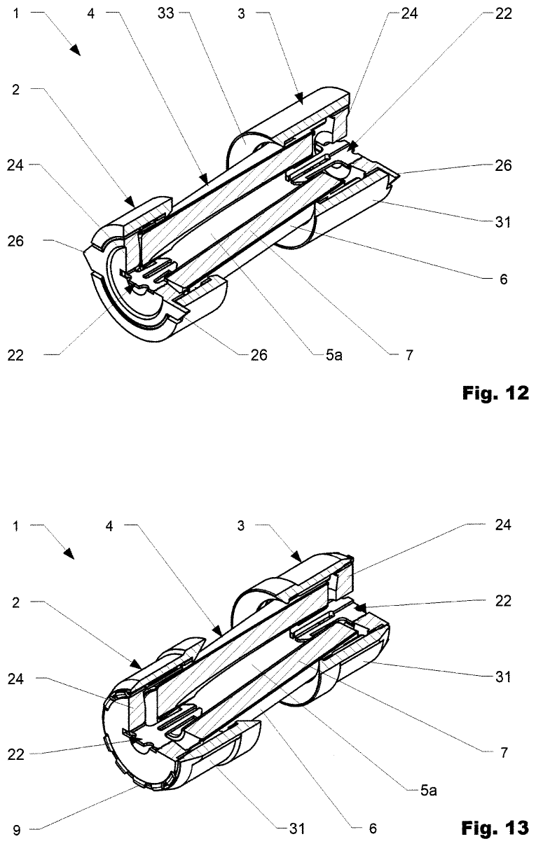

FIGS. 11 and 12 show another embodiment of a board to board connector assembly 1 according to the present invention. In this embodiment, both of the connector sub-assemblies 2 and 3 each comprise a spring cage 8a in the sense of the present invention. The plug connector 4 is essentially cylindrical with a hollow tube 5a as inner conductor. Also, the outer conductor 6 is tubular and comprises at its top edge a collar 30, which extends radially away from the plug connector 4, to engage in an assembled state with a spring element 12 of the first connector sub-assembly 2, to secure the plug connector 4 along the center axis A1. The bottom edge of the outer conductor 6 is crimped.

FIG. 13 shows a further embodiment of a board to board connector assembly 1 according to the present invention. In this embodiment, the spring cage 8 comprises solder tails 9 to be directly soldered on a PCB.

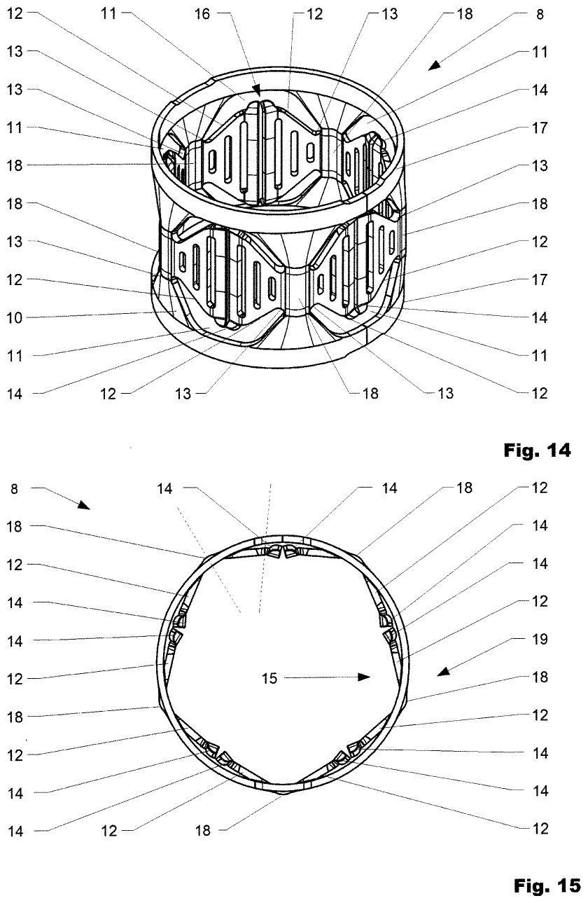

FIG. 14 shows a detailed view of a spring cage 8 of a board to board connector assembly 1 according to the present invention. The spring cage 8 is in the form of a tubular sleeve. It comprises of a pair of straps 17 at its edges, which are connected by bridges 18. The bridges 18 extend parallel to the center axis. The side wall 10 of the sleeve comprises a plurality of openings 11, which are defined by the of straps 17 and the bridges 18. The spring elements 12 are arranged in the openings 11, presently two spring elements 12 in each opening 11. For each spring element 12, a proximal end 13 is connected to the tubular sleeve, i.e. the bridges 18. Each spring element 12 further has a distal end 14. The spring elements 12 become wider from their proximal ends 13 to their distal ends 14. The distal ends 14 of the spring elements each form a contact zone 16. In the present example, the contact zones 16 are linear. The contact zones 16 of the two spring elements 12 are arranged in the same opening 11 are adjacent to each other.

From the top view of FIG. 15, it is apparent that the spring elements 12 are between the proximal end 13 and the distal end 14 arranged along secants of the tubular sleeve. Furthermore, as indicated by the dotted lines, the spring element 12 are between their proximal ends 13 and distal ends 14 bent twice along the secant. It can also be seen from this view that the bridges 18 extend above an outer face 19 of the tubular sleeve.

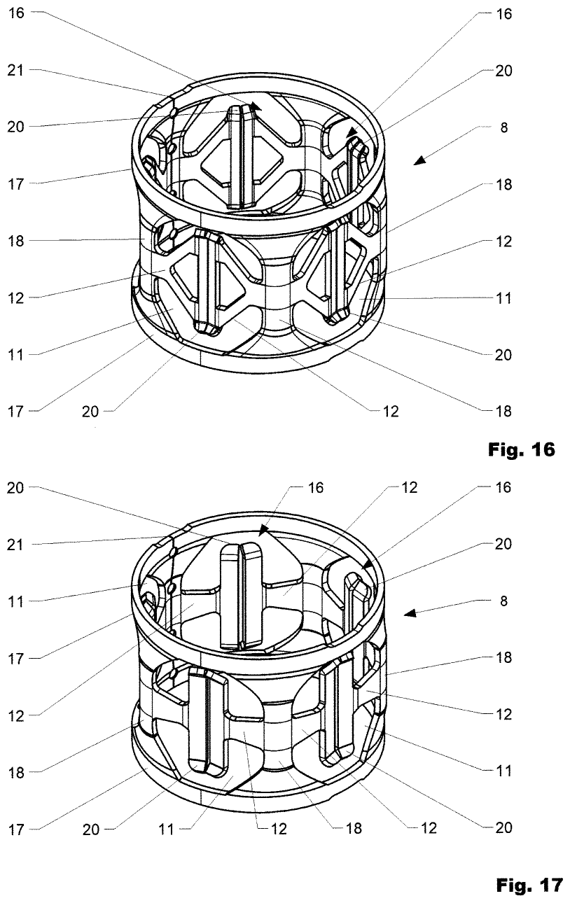

FIGS. 16 and 17 show alternative embodiments of a spring cage 8, which are closely related to the one according to FIGS. 14 and 15. In these figures, each contact zone 16 comprises two sloped inlets 20 for inserting a plug connector 4 into the spring cage 8. Furthermore, it is apparent that the spring cages 8 were made as stamping-and-bending parts, which were bent with respect to the center axis and welded along an interface 21.

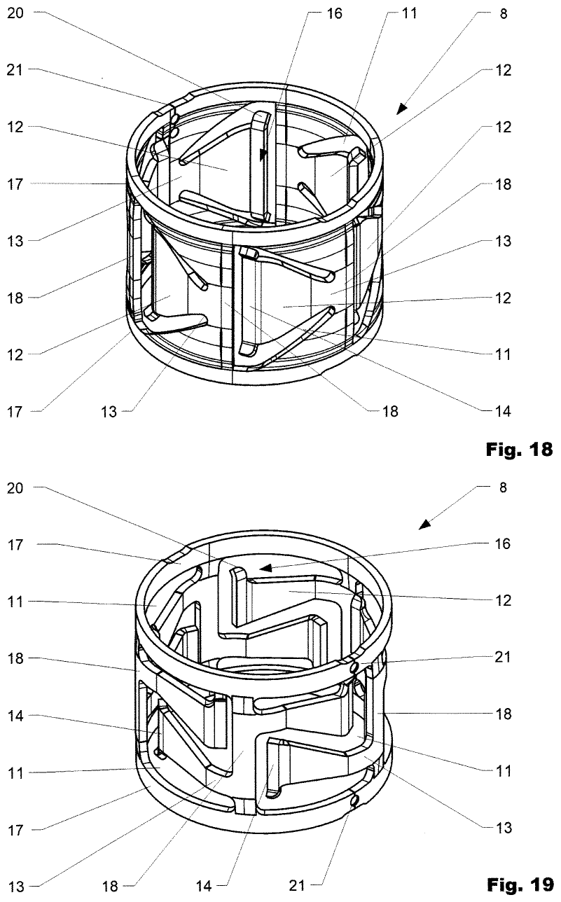

FIG. 18 shows a further embodiment of a spring cage 8 with only one spring element 12 in each opening 11. In the embodiment according to FIG. 19, two spring elements 12 are arranged in one opening 11, with the contact zones 16 of the at least two spring elements 12 being arranged at opposite ends of the opening 11.

Rather, the words used in the specification are words of description rather than limitation, and it is understood that various changes may be made without departing from the spirit and scope of the invention.

1. A board to board connector assembly for interconnecting a first and a second printed circuit board spaced a distance apart from each other, the board to board connector assembly comprising a first connector sub-assembly and a second connector sub-assembly, interconnected to each other in an assembled state by a plug connector, the plug connector comprising:
a. an inner conductor and an outer conductor extending in a direction of a center axis and
b. a spacer arranged between and positioning the inner conductor with respect to the outer conductor
wherein at least one selected from the group consisting of the first and the second connector sub-assemblies, comprises a spring cage having a tubular sleeve having a side wall comprising several openings, each having at least one spring element arranged therein which at a proximal end is connected to the tubular sleeve, and at a distal end extends above an inner face of the tubular sleeve forming at least one contact zone which in the assembled state is in electrical contact with the outer conductor of the plug connector.

2. The board to board connector assembly according to claim 1, wherein the at least one spring element is between the proximal end and the distal end at least partially arranged along a secant of the tubular sleeve in a top view.

3. The board to board connector assembly according to claim 2, wherein the at least one spring element is between the proximal end and the distal end bent along the secant.

4. The board to board connector assembly according to claim 2, wherein the at least one spring element becomes wider between the proximal end and the distal end along the secant.

5. The board to board connector assembly according to claim 1, wherein at least two spring elements are arranged in one opening, with the contact zones of the at least two spring elements arranged adjacent to each other or at opposite ends of the opening.

6. The board to board connector assembly according to claim 1, wherein the tubular sleeve comprises at least a first strap encircling the center axis, with the at least one spring element being connected to the at least one strap by a bridge

7. The board to board connector assembly according to claim 6, wherein the bridge has an extension in a direction parallel to the center axis, is preferably oriented parallel to the center axis and extends above an outer face of the tubular sleeve.

8. The board to board connector assembly according to claim 1, further comprising an outer contact, in which the spring cage is placed.

9. The board to board connector assembly according to claim 6, wherein the bridge extends from the first strap to a second strap

10. The board to board connector assembly according to claim 1, wherein the at least one contact zone is linear or punctiform.

11. The board to board connector assembly according to claim 1, wherein the at least one contact zone comprises at least one sloped inlet along the center axis.

12. The board to board connector assembly according to claim 1, wherein the spring cage is made as a stamping-and-bending part, which is bent with respect to the center axis.

13. The board to board connector assembly according to claim 1, wherein at least one selected from the group consisting of the first and the second connector sub-assemblies comprises an inner contact.

14. The board to board connector assembly according to claim 13, wherein the inner contact is a stamping part made of a sheet metal, which comprises at least two spring fingers which in the assembled state extend along the center axis into the inner conductor or encompass the inner conductor.

15. The board to board connector assembly according to claim 13, wherein the inner contact is a bent wire, which comprises at least two spring fingers which in the assembled state extend along the center axis into the inner conductor or encompass the inner conductor.

16. The board to board connector assembly according to claim 14, wherein the inner contact comprises two spring fingers which are either arranged in one common plane, or inversely twisted out of a plane lying in between the two spring fingers

17. The board to board connector assembly according to claim 1, wherein at least one selected from the group consisting of the first connector sub-assembly and the second connector sub-assembly comprises an isolating element which comprises a recess in which the inner contact is arranged.

18. The board to board connector assembly according to claim 17, wherein the isolating element comprises at least one lug, which laterally extends away from the isolating element with respect to the center axis engaging, in the assembled state, with a recess of the plug connector.

19. The board to board connector assembly according to claim 1, wherein at least one selected from the group consisting of the outer contact and the spring element of the first connector sub-assembly has the same extension along the center axis as at least one selected from the group consisting of the outer contact and the spring element of the second connector sub-assembly.

20. The board to board connector assembly according to claim 1, wherein the outer conductor of the plug connector comprises a recess with which the spring element of the second connector sub-assembly, engages in the assembled state.

21. The board to board connector assembly according to claim 1, wherein a collar is arranged at the outer conductor of the plug connector and extends radially away from the plug connector, to engage, in an assembled state, with the first connector sub-assembly or the second connector sub-assembly, particular to secure the plug connector along the center axis

22. A plug connector for a board to board connector assembly according to claim 1, the plug connector comprising:
a. an inner conductor and an outer conductor extending in a direction of a center axis; and
b. a spacer arranged between and positioning the inner conductor with respect to the outer conductor
wherein the spacer of the plug connector is a layer of insulating material which is extruded over the inner conductor.

23. The plug connector according to claim 22, wherein the inner conductor is a hollow tube or a cylindrical pin.

24. The plug connector according to claim 22, wherein the outer conductor is tubular and made of metallic material.

25. The board to board connector assembly according to claim 1, comprising a plug connector comprising an inner conductor and an outer conductor extending in a direction of a center axis; and a spacer arranged between and positioning the inner conductor with respect to the outer conductor, wherein the spacer of the plug connector is a layer of insulating material which is extruded over the inner conductor.

26. A method for producing a plug connector, according to claim 22, wherein the method comprises the following steps:
providing an inner conductor;
extruding a spacer in form of a layer onto the inner conductor;
placing the inner conductor and spacer in an outer conductor in form of a tubular semi-finished product made of metallic material;
shaping the outer conductor to bring the diameter of the tubular semi-finished product to the final diameter;
cutting the plug connector to the desired length.
